(19) United States
(12) Patent Application Publication
(10) Pub. No.: US 2007/0238002 A1
(43) Pub. Date: Oct. 11, 2007

(54) Fuel cell system with acid trap

(76) Inventors: Lucilla L.E. Schaap, 't Harde (NL); Mihail Penev, Albany, NY (US); Wayne Huang, Shanghai (CN); Nazarali Merchant, Albany, NY (US); Dick Lieftink, Warnsveld (NL); Christopher James Chuah, Clifton Park, NY (US); Gregory C. Pacifico, Latham, NY (US); Richard Hayes Cutright, Corinth, NY (US)

Correspondence Address: FISH & RICHARDSON PC, P.O. BOX 1022, MINNEAPOLIS, MN, 55440-1022, US

(21) Appl. No.: 11/399,229

(22) Filed: Apr. 6, 2006

(51) Int. Cl. H01M 8/04

(52) U.S. Cl. 429/34; 429/13

(57) ABSTRACT

We disclose a system that includes a fuel cell which during operation exhausts a fluid composition that includes an acid or a derivative of the acid, and an acid trap arranged to receive the fluid composition and configured to reduce a concentration of the acid or the derivative of the acid in the fluid composition.

### STATEMENT AS TO FEDERALLY SPONSORED RESEARCH

This invention was made with Government support under NIST Cooperative Agreement Number 70NANB1H3065. The Government has certain rights in this invention.

### TECHNICAL FIELD

This invention relates to fuel cells and fuel cell systems that include acid traps.

### BACKGROUND

A fuel cell can convert chemical energy to electrical energy by promoting electrochemical reactions between two reactants.

One type of fuel cell includes a cathode flow field plate, an anode flow field plate, a membrane electrode assembly disposed between the cathode flow field plate and the anode flow field plate, and two gas diffusion layers disposed between the cathode flow field plate and the anode flow field plate. A fuel cell can also include one or more coolant flow field plates disposed adjacent the exterior of the anode flow field plate and/or the exterior of the cathode flow field plate.

Each flow field plate has an inlet region, an outlet region and open-faced channels connecting the inlet region to the outlet region and providing a way for distributing the gases to the membrane electrode assembly.

The membrane electrode assembly usually includes a solid electrolyte (e.g., a proton exchange membrane, commonly abbreviated as a PEM) between a first catalyst and a second catalyst. One gas diffusion layer is between the first catalyst and the anode flow field plate, and the other gas diffusion layer is between the second catalyst and the cathode flow field plate.

During operation of the fuel cell, one of the gases (the anode gas) enters the anode flow field plate at the inlet region of the anode flow field plate and flows through the channels of the anode flow field plate toward the outlet region of the anode flow field plate. The other gas (the cathode gas) enters the cathode flow field plate at the inlet region of the cathode flow field plate and flows through the channels of the cathode flow field plate toward the cathode flow field plate outlet region.

As the anode gas flows through the channels of the anode flow field plate, the anode gas diffuses through the anode gas diffusion layer and interacts with the anode catalyst. Similarly, as the cathode gas flows through the channels of the cathode flow field plate, the cathode gas diffuses through the cathode gas diffusion layer and interacts with the cathode catalyst.

The anode catalyst interacts with the anode gas to catalyze the conversion of the anode gas to reaction intermediates. The reaction intermediates include ions and electrons. The cathode catalyst interacts with the cathode gas and the anode reaction intermediates to catalyze the conversion of the cathode gas to the chemical product of the fuel cell reaction.

The chemical product of the fuel cell reaction flows through a gas diffusion layer to the channels of a flow field plate (e.g., the cathode flow field plate). The chemical product then flows along the channels of the flow field plate toward the outlet region of the flow field plate.

The electrolyte provides a barrier to the flow of the electrons and gases from one side of the membrane electrode assembly to the other side of the membrane electrode assembly. However, the electrolyte allows ionic reaction intermediates to flow from the anode side of the membrane electrode assembly to the cathode side of the membrane electrode assembly.

Therefore, the ionic reaction intermediates can flow from the anode side of the membrane electrode assembly to the cathode side of the membrane electrode assembly without exiting the fuel cell. In contrast, the electrons flow from the anode side of the membrane electrode assembly to the cathode side of the membrane electrode assembly by electrically connecting an external load between the anode flow field plate and the cathode flow field plate. The external load allows the electrons to flow from the anode side of the membrane electrode assembly, through the anode flow field plate, through the load, to the cathode flow field plate, and to the cathode side of the membrane electrode assembly.

Electrons are formed at the anode side of the membrane electrode assembly, indicating that the anode gas undergoes oxidation during the fuel cell reaction. Electrons are consumed at the cathode side of the membrane electrode assembly, indicating that the cathode gas undergoes reduction during the fuel cell reaction.

For example, when hydrogen and oxygen are the gases used in a fuel cell, hydrogen flows through the anode flow field plate and undergoes oxidation. Oxygen flows through the cathode flow field plate and undergoes reduction. The specific reactions that occur in the fuel cell are represented in equations 1-3.
H₂→2H⁺+2e⁻ (1)
½O₂+2H⁺+2e⁻→H₂O (2)
H₂+½O₂→H₂O (3)

As shown in Equation 1, hydrogen forms protons (H⁺) and electrons. The protons flow through the electrolyte to the cathode side of the membrane electrode assembly, and the electrons flow from the anode side of the membrane electrode assembly to the cathode side of the membrane electrode assembly through the external load. As shown in Equation 2, the electrons and protons react with oxygen to form water. Equation 3 shows the overall fuel cell reaction.

In addition to forming chemical products, the fuel cell reaction produces heat. One or more coolant flow field plates are typically used to conduct the heat away from the fuel cell and prevent it from overheating.

Each coolant flow field plate has an inlet region, an outlet region and channels that provide fluid communication between the coolant flow field plate inlet region and the coolant flow field plate outlet region. A coolant (e.g., liquid de-ionized water) at a relatively low temperature enters the coolant flow field plate at the inlet region, flows through the channels of the coolant flow field plate toward the outlet region of the coolant flow field plate, and exits the coolant flow field plate at the outlet region of the coolant flow field plate. As the coolant flows through the channels of the coolant flow field plate, the coolant absorbs heat formed in the fuel cell. When the coolant exits the coolant flow field plate, the heat absorbed by the coolant is removed from the fuel cell.

To increase the electrical energy available, a plurality of fuel cells can be arranged in series to form a fuel cell stack. In a fuel cell stack, one side of a flow field plate functions as the anode flow field plate for one fuel cell while the opposite side of the flow field plate functions as the cathode flow field plate in another fuel cell. This arrangement may be referred to as a bipolar plate. The stack may also include monopolar plates such as, for example, an anode coolant flow field plate having one side that serves as an anode flow field plate and another side that serves as a coolant flow field plate. As an example, the open-faced coolant channels of an anode coolant flow field plate and a cathode coolant flow field plate may be mated to form collective coolant channels to cool the adjacent flow field plates forming fuel cells.

### SUMMARY

In one aspect, the invention features a system that includes a fuel cell which during operation exhausts a fluid composition that includes an acid or a derivative of the acid, and an acid trap arranged to receive the fluid composition and configured to reduce a concentration of the acid or the derivative of the acid in the fluid composition.

Embodiments of the system can include any of the following features.

The acid can be phosphoric acid.

The acid trap can include a first region of a first material, and a second region of a second material different from the first material. The first material can include channels that have a mean diameter d₁ and that extend through a length of the first material, and the channels can form an array extending in a direction of flow of the first fluid composition along the length of the first material. The second material can include channels that have a mean diameter d₂ and that extend through a length of the second material. Mean diameter d₁ can be larger than mean diameter d₂.

The first material can be a ceramic material. The ceramic material can be coated with at least one of an activated carbon material and a silica material.

The first material can be a zeolite material.

The second material can be a ceramic material. The ceramic material can be coated with at least one of an activated carbon material and a silica material.

The second material can be a zeolite material.

The acid trap can be arranged so that the first fluid composition flows through the first region and then through the second region. The first material can be configured to adsorb the acid or derivative of the acid from the first fluid composition.

The fuel cell can be a component of a fuel cell stack. For example, the acid trap can form a portion of a gas diffusion layer in the fuel cell stack. Alternatively, or in addition, the acid trap can form a portion of a flow field plate in the fuel cell stack.

In another aspect, the invention features a method that includes directing a fluid composition exhausted from a fuel cell to flow through an acid trap, where the fluid composition includes an acid or a derivative of the acid, and the acid trap reduces a concentration of the acid or the derivative of the acid in the fluid composition.

Embodiments of the method can include any of the following features.

The acid can be phosphoric acid.

The fluid composition can be directed to the fuel cell after the fluid composition has flowed through the acid trap.

Embodiments may include one or more of the following advantages. For example, a filter (e.g., an acid trap) can reduce an amount of an undesirable compound (e.g., an acid) present in exhaust gases from a fuel cell system, thereby reducing undesirable emissions from a fuel cell system into the environment.

Embodiments can also feature fuel cell systems with improved durability relative to comparable fuel cell systems that do not include a filter. Filters can reduce the amount of undesirable compounds/contaminants that are present within the fuel cell system, thereby reducing the amount of damage to the fuel cell system due to the compound. For example, corrosive impurities, such as acids, can degrade metal conduits used to transport gases, and can also degrade other metal and non-metal components of fuel cell systems such as flow channels, valves, and housings. In addition, some impurities can deposit on process catalysts used to enable various chemical reactions in fuel cell systems. For example, impurity materials can deposit on catalysts present in a reformer and used to convert fuel gas to reformate. The deposition of impurities on reformer catalyst surfaces can lead to accelerated deactivation or “poisoning” of the catalysts and less efficient operation of the fuel cell system. Using a filter, such as an acid filter, to reduce the amount of impurities in a fuel cell system can reduce these adverse affects, thereby prolonging the operational lifetime of the system or of components of the system.

Unless otherwise defined, all technical and scientific terms used herein have the same meaning as commonly understood by one of ordinary skill in the art to which this invention belongs.

The details of one or more embodiments of the invention are set forth in the accompanying drawings and the description below. Other features and advantages of the invention will be apparent from the description, drawings, and claims.

### DESCRIPTION OF DRAWINGS

FIG. 1 is a schematic diagram of an embodiment of a fuel cell system.

FIG. 2 is a schematic diagram of an embodiment of an acid trap.

FIG. 3 is a cross-sectional view of an embodiment of a fuel cell.

FIG. 4 is a schematic diagram of another embodiment of a fuel cell system.

Like reference symbols in the various drawings indicate like elements.

### DETAILED DESCRIPTION

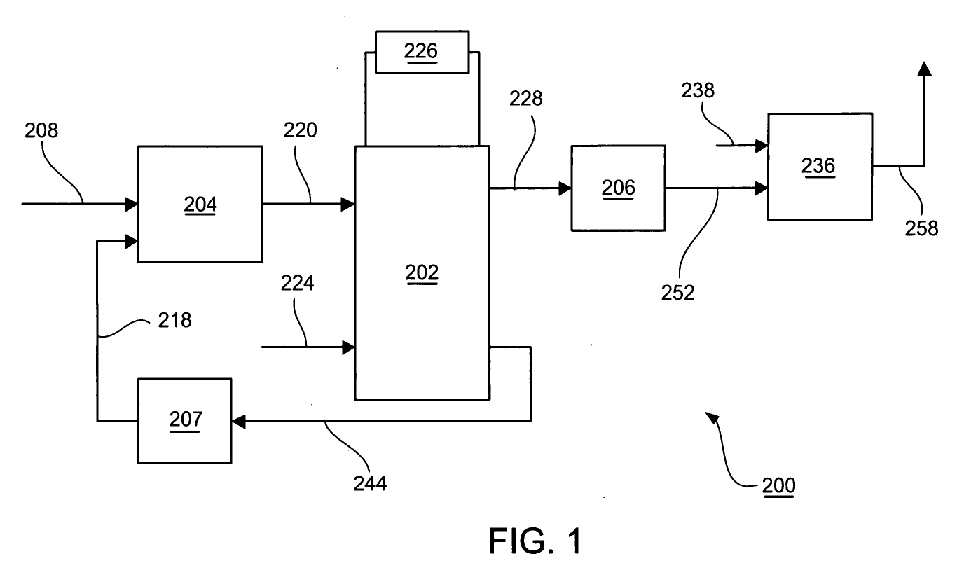

Referring to FIG. 1, a fuel cell system 200 includes a fuel cell stack 202 (including one or more fuel cells), a reformer 204, and a burner 236. Fuel cell system 200 is configured so that fuel cell stack 202 applies a voltage across an external load 226.

Fluid flow between various components of fuel cell system 200 may be controlled using one or more regulators (not shown in FIG. 1).

During operation, a fuel (e.g., methane or methanol) enters fuel cell system 200 through a fuel inlet 208. Inlet 208 directs the fuel to reformer 204, which produces a reformate (e.g., a H₂-rich reformate) from the fuel and directs the reformate to fuel cell stack 202 via a conduit 220.

A cathode gas (e.g., air) enters fuel cell stack 202 through an inlet line 224. Inside the fuel cell stack 202, the anode and cathode gases react, producing electrical power that flows through external load 226. Fuel cell stack 202 also produces one or more chemical byproducts (e.g., water). The exhaust gas from the anode in fuel cell stack 202 exits fuel cell stack 202 through a conduit 228, which directs the gas to a first acid trap 206. The exhaust gas from the cathode in fuel cell stack 202 exits via a conduit 244, which directs the gas to a second acid trap 207.

First and second acid traps, 206 and 207 reduce the concentration of acid (and/or a derivative of an acid) in the gases exhausted from fuel cell stack 202. These components are discussed in more detail below. Gas exiting acid trap 206 is conveyed via a conduit 252 to a burner 236 which oxidizes the gas exhausted from the fuel cell stack anode before exhausting the gas via an exhaust conduit 258 into the environment. During operation, burner 236 draws air from through an inlet 238. Gas exiting acid trap 207 is convey via a conduit 218 back to reformer 204, where it is added to the reformate produced by reformer 204.

In general, the acid or acid derivative may come from a variety of sources in fuel cell system 200. For example, in some embodiments, phosphoric acid and/or its chemical derivatives may leech out from ion exchange membranes in one or more of the fuel cells in fuel cell stack 202. Sources of phosphoric acid and its derivatives are discussed below. These compounds can poison catalysts used in reformer 204 and can corrode conduits, fixtures, and other elements of system 200. Further, these compounds can be vented to the environment surrounding fuel cell system 200 through vent 258, with adverse health consequences for humans and other living entities.

Either or both of the anode exhaust gas and the cathode exhaust gas can include concentrations of phosphoric acid and/or its derivatives that are higher than a determined concentration limit for the safe and reliable operation of system 200 (e.g., that reduce the operational lifetime of fuel cell system 200 due to corrosion, and/or exceed emissions standards). Acid traps 206 and 207 can be used to reduce a concentration of phosphoric acid and/or its derivatives in a gas stream to a levels that fall under these concentration limits.

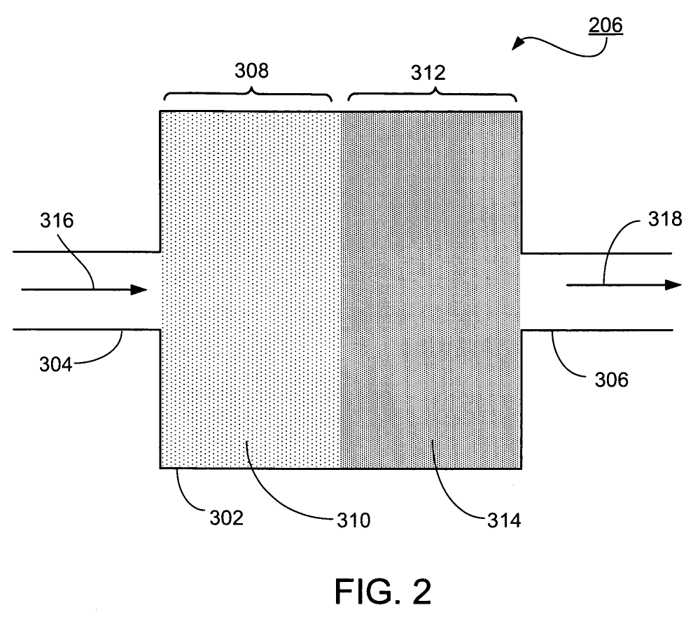

In general, the structure of acid traps 206 and 207 may vary as desired. Referring to FIG. 2, in some embodiments, acid trap 206 includes a container 302 having an influent conduit 304 and an effluent conduit 306. A first flow portion 308 of filter 206 includes a first filter material 310. A second flow portion 312 of filter 206 includes a second filter material 314. Influent gas 316 is directed to flow into influent conduit 304, through first filter material 310, through second filter material 314, and subsequently out of effluent conduit 306 as filtered gas 318.

Each of first filter material 310 and second filter material 314 include flow channels or pores. The channels or pores extend through the length of the material and are substantially oriented in a direction parallel to the flow of influent gas 316. First filter material 310 includes channels having a mean cross-sectional diameter d₁ that is larger than a mean cross-sectional diameter d₂ of the channels in second filter material 314. In certain embodiments, d₁>d₂. For example, in some embodiments, d₁ can be about 1.5×d₂ or more (e.g., about 2×d₂ or more, about 3×d₂ or more, about 4×d₂ or more, about 5×d₂ or more, about 10×d₂ or more).

Selected components in an influent gas stream generally adsorb onto the walls of the channels in the first and second filter materials. Once a monolayer of adsorbed component material covers the channel walls, further component material is adsorbed atop the already-deposited component material. The diameter of channel openings decreases as the build-up of component material on the walls of the channels increases, thereby reducing the flow capacity of the channels.

Due to their larger mean channel diameter, the channels in first filter material 310 can adsorb relatively large quantities of one or more impurity components before gas flow through the channels is unduly restricted. In contrast, due to their smaller mean channel diameter, the channels in second filter material 314 can adsorb relatively small quantities of one or more impurity components before gas flow through the channels is unduly restricted. However, due to their smaller mean channel diameter, the channels in second filter material 314 collectively provide a larger surface area for adsorption of impurity components, and therefore more efficiently reduce a concentration of impurity components in an influent gas. Thus, the first material acts as a coarse filter, which reduces the contaminant concentration to the second filter material. The second filter material then acts as a fine-polish while remaining unclogged longer due to the lower feed contaminant concentration. Overall, the combination of the two materials provides longer life and better filtering characteristics than a single material can provide.

Embodiments of acid traps generally use two or more filter materials to cooperatively reduce a concentration of one or more particular components in influent gas 316. For example, first filter material 310, due to its large adsorption capacity, functions as a “coarse” filter in order to adsorb a relatively large amount of one or more impurity components present in a relatively high concentration in influent gas 316 flowing through the channels of first filter material 310. Passage through first filter material 310 generates an intermediate gas from influent gas 316, where the intermediate gas has a concentration of one or more impurity components that is reduced by a relatively large amount compared with influent gas 316. Second filter material 314, due to its relatively large channel surface area and relatively small adsorption capacity, functions as a “fine” filter in order to adsorb a relatively small amount of one or more impurity components which are present in a relatively low concentration in the intermediate gas flowing through the channels of second filter material 314. Passage through second filter material 314 generates filtered gas 318 from the intermediate gas, where filtered gas 318 has a concentration of one or more impurity components that is reduced by a relatively small amount compared with the intermediate gas. By using first filter material 310 to adsorb a relatively large amount of one or more impurity components, a concentration of these impurity components in filtered gas 318 can be reduced without severely impeding the flow of influent gas 316 through acid trap 206. By using second filter material 314, a concentration of the impurity components in filtered gas 318 can be reduced even further without clogging or obstructing the channels of second filter material 314 too severely. First filter material 310 and second filter material 314 can therefore be used cooperatively to provide the dual advantages of significantly reducing a concentration of one or more impurity components in influent gas 316, and maintaining a flow rate of influent gas 316 that is sufficiently high so that operation of the fuel cell system is not impaired.

As an example, first filter material 310 can include an extruded ceramic monolith material (available, for example, from Corning Inc., Corning, N.Y.) having about 150 cells per square inch (CPSI) or less (e.g., about 100 CPSI or less, about 75 CPSI or less, about 50 CPSI or less, about 25 CPSI or less). Second filter material 314 can include an extruded ceramic monolith material (also available from Corning) having about 250 CPSI or more (e.g., about 300 CPSI or more, about 350 CPSI or more, about 400 CPSI or more, about 500 CPSI or more, about 600 CPSI or more). The material can also be metallic monolith, which operates to absorb contaminants since contaminants would react with metals and thus begin the adsorption cake formation. Each of first filter material 310 and second filter material 314 can be provided in the form of a solid brick, e.g., a rectangular brick having dimensions 6″×6″ on an end face (oriented substantially perpendicular to a direction of flow of influent gas 316) and 12″ long (in a direction substantially parallel to a direction of influent gas flow). Other shape bricks, such as round or oval bricks, can also be used. Generally, the dimensions of the brick cross-sections can be free variables for design capacity. The brick length is typically a function of the filtering level desired. The two materials can be encased in a container 302 such as a steel canister, and positioned therein such that the channels in each of first filter material 310 and second filter material 314 are oriented substantially in a direction of flow of influent gas 316. Further, first filter material 310 is positioned within container 302 in first flow portion 308 such that it is adjacent to influent conduit 304, and second filter material 314 is positioned in second flow portion 312 adjacent to effluent conduit 306. The two filter materials provide for sequential filtering of influent gas 316. The flow portions are generally designed so that the flow velocity through the materials are relatively even throughout the cross-sectional area. Sufficient flow transition space can also be provided prior to the gas exiting into subsequent piping Typically, each material reduces the gas concentration of contaminants by an approximately fixed percentage per unit length. This percentage is approximately inversely proportional to flow rate, and approximately proportional to the surface area of the monolith. So, filtration at half flows or half-power of the fuel cell, would provide approximately twice the filtration level—so that the initial concentration may be reduced to 0.5% of the original concentration. At full flows (full power of the fuel cell), the concentration would then be reduced to about 1% of the original concentration. In some embodiments, first filter material 310 can reduce a concentration of one or more contaminants (e.g., acid or acid derivative) to about 20% or less (e.g., about 10% or less, about 5% or less, about 2% or less) of its initial concentration at full flow. In certain embodiments, second filter material 314 can reduce a concentration of one or more contaminants (e.g., acid or acid derivative) to about 2% or less (e.g., about 1% or less, about 0.5% or less, about 0.1% or less) of its initial concentration at full flow. In certain embodiments, second filter material 314. In combination, both filter material 310 and filter material 314 can provide a contamination reduction to about 0.5% or less (e.g., about 0.2% or less, about 0.1% or less, about 0.05% or less, about 0.02% or less) of the initial contaminant concentration in influent gas 316 at full flow.

Monolithic filter materials, such as the ceramic monoliths discussed above, used in combination can provide a number of advantages with respect to more conventional pelletized adsorbents or single monolithic adsorbent materials. First, monolithic materials generally do not impede the flow of influent gas as strongly as pelletized materials, due to the presence of channels in the structure of monolithic materials. As a result, the pressure drop introduced by an acid trap based on a combination of monolithic materials is generally less than the pressure drop introduced by a filter having a similar adsorptive capacity and based on a pelletized adsorbent such as alumina pellets or extrudates. For example, the difference between the pressure of influent gas 316 and filtered gas 318 introduced by acid trap 206 can be about 5 mbar or less (e.g., about 3 mbar or less, about 1 mbar or less). As the assembly becomes saturated, the pressure drop may increase.

Second, monolithic materials generally provide a larger available surface area for adsorption of components in an influent gas than is provided by a bed of pelletized absorbent. For example, an acid trap 206 constructed as described above, including coarse and fine monolithic ceramic adsorbents, may provide a large adsorbent surface area, so that about 50% or more (e.g., about 60% or more, about 70% or more, about 80% or more) of the volume of the adsorbent is available for adsorbing one or more components from the influent gas. By contrast, using a similar volume of a pelletized alumina adsorbent provided in an adsorbing bed, only about 35% of the volume of the adsorbent material may be available for adsorbing components from the influent gas.

Third, the use of two monolithic materials can increase the usable lifetime of the filter, relative to the usable lifetime of a filter having a single monolithic filter material. For example, in fuel cell systems, a cathode exhaust gas leaving a fuel cell stack may include concentrations of a component such as phosphoric acid (and/or one or more of its chemical derivatives) of parts per million (ppm). In order to ensure safe and reliable operation of the fuel cell system, the concentration of phosphoric acid may need to be reduced to less than 30 ppb before the cathode exhaust gas is combined with reformer oxidant gas and directed into a fuel reformer. In order to reduce the concentration of phosphoric acid to less than 30 ppb, a relatively fine monolithic material may be required (e.g., having about 300 CPSI or more). However, given the relatively high initial concentration of phosphoric acid in the cathode exhaust gas, the pores in a fine monolithic material may become rapidly obstructed with adsorbed phosphoric acid, impeding the flow of influent gas through the filter material, and necessitating replacement of the monolithic material with fresh filter material having unobstructed channels.

A filter material that includes both coarse and fine monolithic adsorbents can have a significantly longer lifetime. The coarse adsorbent material can be used to adsorb a relatively large amount, such as about 80% or more (e.g., about 90% or more, about 95% or more, about 97% or more) of the phosphoric acid present in an influent gas. The fine adsorbent material can then be used in sequential fashion to adsorb about 90% or more (e.g., about 95% or more) of the remaining phosphoric acid in the influent gas. Due to the action of the coarse adsorbent material, the amount of phosphoric acid adsorbed by the fine adsorbent material for a given flow rate of influent gas is much less than the amount of phosphoric acid adsorbed by a fine adsorbent material acting alone, and therefore a filter material that includes both coarse and fine adsorbents can have a significantly longer lifetime.

Embodiments of acid trap 206 can also include other monolithic adsorbent materials. For example, in addition or as alternatives to the ceramic materials discussed above, filter 206 can include corrugated metal monolithic adsorbent materials (available, for example, from Johnson Matthey PLC, London, UK). Metal monolithic materials can include flow channels or passages for gas flow that provide for even less obstruction than the channels in ceramic monoliths, and may therefore contribute an even smaller pressure drop when a filter 206 that includes these materials is incorporated into a fuel cell system. Both coarse and fine metal monoliths can be used in combination in acid trap 206 to provide the same advantages as those associated with ceramic monoliths. In other embodiments, for example, acid trap 206 can include materials such as zeolites, activated carbon, silica, and other porous materials. Filter 206 can further include one or more adsorbent materials coated on channel walls in porous materials such as ceramic monoliths or foams. For example, filter 206 can include a ceramic monolith having adsorptive surfaces coated with particles of activated carbon or silica in order to further enhance the adsorptive capability of the filter and/or in order to preferentially adsorb a particular component in an influent gas.

As shown in FIG. 2, acid trap 206 includes a first filter material 310 and a second filter material 314. In general, however, embodiments of filter 206 can include more than two filter materials. For example, filter 206 can include three or more filter materials (e.g., four or more filter materials, five or more filter materials, ten or more filter materials) in order to reduce a concentration of one or more components in an influent gas to a desired concentration in effluent conduit 306 of the filter, and in order to extend the useful operating lifetime of the filter in a fuel cell system. In some embodiments, a filter includes three filter portions each formed from a different material. The third portion includes channels with a mean cross-sectional diameter d₃. In some cases, d₃<d₂. Alternatively, d₃=d₂. The third filter portion can include a material that is coated for very fine filtration of trace contaminants.

In general, acid trap 206 is positioned to receive a gas such as cathode exhaust gas and to reduce a concentration of one or more components in the gas. In some embodiments, such as the embodiment of FIG. 2 for example, filter 206 can be positioned to receive a mixture of reformer oxidant gas and cathode exhaust gas, and may filter this mixture of gases to remove one or more components such as phosphoric acid and/or one or more of its chemical derivatives. Due to the poisoning effects of phosphoric acid with respect to reformer catalysts, acid trap 206 is generally positioned upstream from reformer 204 along a gas flow path in a fuel cell system, in order to reduce a concentration of phosphoric acid that is introduced into the reformer.

Acid trap 207 may be the same or different than acid trap 206.

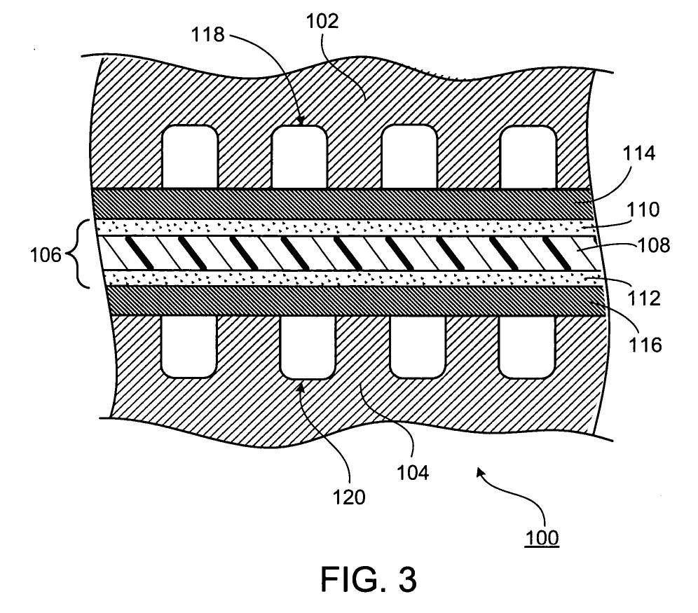

Referring to FIG. 3, an embodiment of a fuel cell 100 includes a cathode flow field plate 102, an anode flow field plate 104, a membrane electrode assembly 106 having an ion exchange membrane 108, cathode catalyst layer 110, and anode catalyst layer 112. Gas diffusion layers 114 and 116 separate membrane electrode assembly 106 from flow field plates 102 and 104. During operation of the fuel cell, anode gas is directed to flow through channels 120 in anode flow field plate 104 and cathode gas is directed to flow through channels 118 in cathode flow field plate 102. The anode gas passes through anode gas diffusion layer 116 and interacts with anode catalyst layer 112. The anode catalyst catalyzes the conversion of anode gas to reaction intermediates. For example, an anode gas including hydrogen gas can be converted to protons and electrons. The cathode gas passes through cathode gas diffusion layer 114 and interacts with cathode catalyst layer 110. The cathode catalyst catalyzes the conversion of cathode gas to a chemical product of the fuel cell reaction. For example, for an anode gas including hydrogen and a cathode gas including oxygen, the chemical product of the fuel cell reaction can be water.

Ion exchange membrane 108 provides a barrier to the flow of electrons and gases from one side of membrane electrode assembly 106 to the other. However, membrane 108 allows ionic reaction intermediates, such as protons, to flow from the anode side of the membrane electrode assembly to the cathode side. In order to provide this selectivity, ion exchange membrane can include significant quantities of phosphoric acid and its chemical derivatives (e.g., dihydrogen phosphate anions, H₂PO₄⁻, monohydrogen phosphate anions, H₂PO₄²⁻, phosphate anions, PO₄⁻, and the like). The relatively large numbers of negative charges in these substances assist the flow of positively charged ions, such as protons, from the anode side of membrane electrode assembly 106 to the cathode side through ion exchange membrane 108. In contrast, the negative charges assist in preventing the flow of negatively charged species such as electrons and neutral species such as anode and cathode gases through membrane 108.

During operation, phosphoric acid and its chemical derivatives may leech out from ion exchange membrane 108 and be combined with gases flowing out of fuel cell 100 from either or both of the anode and cathode sides.

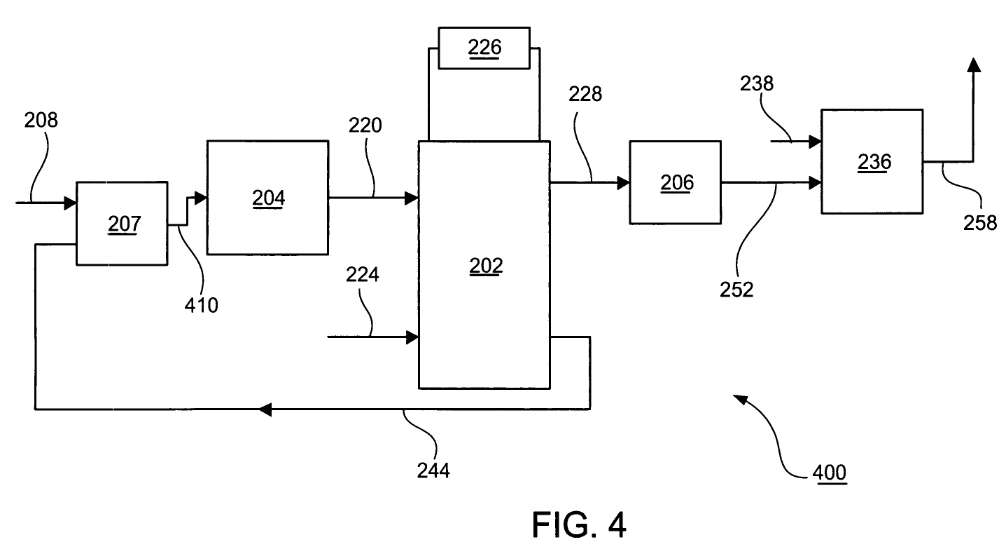

While an embodiment of a fuel cell system is described above, in general, other configurations are also possible. For example, in some embodiments, acid trap 207 can be used to filter fuel, in addition to filtering exhaust gas from fuel cell stack 202. For example, FIG. 4 is a schematic diagram of an embodiment of a fuel cell system 400 that is similar to fuel cell system 200. In this embodiment fuel is passed through acid trap 207 and combined with exhaust gas from the cathode of fuel cell stack 202. The filtered fuel mixture is directed to reformer 204 via conduit 410.

In some embodiments, the fuel gas is at a lower temperature than the exhaust gas returning from fuel cell stack 202, and the temperature difference is used to promote precipitation of one or more components such as phosphoric acid in the gas mixture onto the walls of the channels in acid trap 207. By regulating the temperature of the fuel gas, it is possible in some embodiments to adjust the precipitation rate of one or more components of the gas mixture.

In the embodiments shown, the acid traps 206 and 207 are shown being distinct components of the fuel cell systems. In general, however, the acid trap can also be physically combined with other components of a fuel cell system. For example, an acid trap can be incorporated as a portion of either or both of anode gas diffusion layer 116 and cathode gas diffusion layer 114. Either or both of these gas diffusion layers can have an outer portion comprising coarse and fine filter materials, with channels therein aligned substantially in a direction of gas flow through the diffusion layers. In other embodiments, for example, the acid trap materials can be combined with channels in either or both of the anode and cathode flow field plates in order to reduce concentrations of components such as phosphoric acid and/or its chemical derivatives that leech out from the proton exchange membrane of a fuel cell.

A number of embodiments have been described. Other embodiments are within the scope of the following claims.

What is claimed is:

1. A system, comprising:
a fuel cell which during operation exhausts a fluid composition comprising an acid or a derivative of the acid; and
an acid trap arranged to receive the fluid composition and configured to reduce a concentration of the acid or the derivative of the acid in the fluid composition.

2. The system of claim 1, wherein the acid is phosphoric acid.

3. The system of claim 1, wherein the acid trap comprises a first region of a first material, and a second region of a second material different from the first material.

4. The system of claim 3, wherein the first material comprises channels having a mean diameter d₁ and extending through a length of the first material and the channels form an array extending in a direction of flow of the first fluid composition along the length of the first material.

5. The system of claim 4, wherein the second material comprises channels having a mean diameter d₂ and extending through a length of the second material.

6. The system of claim 5, wherein d₁ is larger than d₂.

7. The system of claim 3, wherein the first material is a ceramic material.

8. The system of claim 7, wherein the ceramic material is coated with at least one of an activated carbon material and a silica material.

9. The system of claim 3, wherein the first material is a zeolite material.

10. The system of claim 3, wherein the second material is a ceramic material.

11. The system of claim 10, wherein the ceramic material is coated with at least one of an activated carbon material and a silica material.

12. The system of claim 3, wherein the second material is a zeolite material.

13. The system of claim 3, wherein the acid trap is arranged so that the first fluid composition flows through the first region and then through the second region.

14. The system of claim 3, wherein the first material is configured to adsorb the acid or derivative of the acid from the first fluid composition.

15. The system of claim 1, wherein the fuel cell is a component of a fuel cell stack.

16. The system of claim 15, wherein the acid trap forms a portion of a gas diffusion layer in the fuel cell stack.

17. The system of claim 15, wherein the acid trap forms a portion of a flow field plate in the fuel cell stack.

18. A method, comprising:
directing a fluid composition exhausted from a fuel cell to flow through an acid trap,
wherein the fluid composition comprises an acid or a derivative of the acid and the acid trap reduces a concentration of the acid or the derivative of the acid in the fluid composition.

19. The method of claim 18, wherein the acid is phosphoric acid.

20. The method of claim 18, further comprising directing the fluid composition to the fuel cell after the fluid composition has flowed through the acid trap.
